(19) United States
(12) Patent Application Publication
(10) Pub. No.: US 2012/0269448 A1
(43) Pub. Date: Oct. 25, 2012

(54) IMAGE PROCESSING APPARATUS AND IMAGE PROCESSING METHOD

(75) Inventor: Makoto Kimura, Kawasaki-shi (JP)

(73) Assignee: CANON KABUSHIKI KAISHA, Tokyo (JP)

(21) Appl. No.: 13/443,801

(22) Filed: Apr. 10, 2012

(30) Foreign Application Priority Data
Apr. 19, 2011 (JP) 2011-093512
Mar. 28, 2012 (JP) 2012-074889

(51) Int. Cl. G06K 9/36

(52) U.S. Cl. 382/233

(57) ABSTRACT

A variable-length code stream is read out from a position designated as a start position of an encoded stream of a block of interest, and the readout stream is decoded. Upon completion of the decoding of the variable-length code stream of the block of interest, a data length of a semi-fixed-length data stream of the block of interest is calculated. A position the data length behind the start position of the semi-fixed-length data stream is designated as a start position of an encoded stream of a next block to be decoded after the block of interest, and decoding of a variable-length code stream of the next block is started.

### BACKGROUND OF THE INVENTION

1. Field of the Invention

The present invention relates to an image decoding technique.

2. Description of the Related Art

The recent advance of semiconductor technologies is amazing to allow many digital cameras to capture high-resolution images, and the data sizes of captured images are increasing accordingly. Most of images captured by digital cameras are compression-encoded by an encoding method such as JPEG, and are then recorded in recording media. For this reason, in order to confirm a captured image on, for example, a display of a digital camera main body, encoded image data has to be decoded in predetermined procedures.

Various encoding methods for still images such as a JPEG encoding method are available. In JPEG encoding, image data is divided into a plurality of blocks each having a predetermined size. These blocks become the unit of encoding and data included in respective blocks undergo orthogonal transform. Then transformation coefficients after this orthogonal transform undergo quantization and coefficient prediction in turn. Furthermore, the data after the coefficient prediction undergo scan, and are converted from two-dimensional data into one-dimensional data including significant coefficients (nonzero data: levels) and a zero runlength of insignificant coefficients (zero data: runs). From the one-dimensional data, which is converted in this way, a plurality of syntax elements are generated, and are entropy-encoded. Finally, codes generated by the entropy encoding are coupled in a predetermined order, thus generating an encoded stream.

In encoding of a JPEG XR encoding method (to be simply referred to as JPEG XR hereinafter), which has been internationally standardized in recent years, as shown in FIG. 4, a prediction error after coefficient prediction is divided into a sign bit (flag) and absolute value. This absolute value is further divided into upper data and lower data, which are respectively encoded by different methods.

After the upper data undergoes adaptive scan, run/level syntax elements are generated, undergo variable-length encoding, and are coupled as an encoded stream. The lower data undergoes adaptive fixed-length coding. In JPEG XR, The transformation coefficient after orthogonal transform consists of DC, Low-pass(LP), and High-pass(HP) coefficients. The adaptive fixed-length coded part of the lower data of DC or lowpass(LP) coefficient is called FLC refinement and that of highpass(HP) coefficient is called flexbits. Hereinafter, both of FLC refinement and flexbits are referred to as semi-fixed-length data. The lower data is coupled to the encoded stream as semi-fixed-length data.

For this reason, in decoding of JPEG XR, transformation coefficient prediction errors for one block can be obtained only after the variable-length codes are decoded, and the semi-fixed-length data are also decoded. Also, before completion of the variable-length decoding, the start position of the semi-fixed-length data in encoded stream cannot be specified. In addition, since the data length (Modelbits in FIG. 4) of the semi-fixed-length data changes depending on the variable-length decoding result, it is difficult to parallelly decode the variable-length code and semi-fixed-length data. As techniques for quickly decoding an encoded stream including a plurality of encoding methods like in the JPEG XR, patent literature 1 (Japanese Patent Laid-Open No. 2010-093522) and patent literature 2 (Japanese Patent Laid-Open No. 2009-273106) are known.

A decoding apparatus described in patent literature 1 has a plurality of variable-length code decoders, and a single Flexbits decoder, and speeds up decoding processing by parallelly decoding a variable-length code and Flexbits. However, in the JPEG XR, since there are a large number of syntax elements in the variable-length encoding, each variable-length code decoder (to be simply referred to as a variable-length decoder hereinafter) requires a large circuit scale. When the plurality of such variable-length decoders are included, the processing performance improvement and a very large increase in circuit scale are required at the same time.

A decoding apparatus described in patent literature 2 has a variable-length decoder and Flexbits decoder. Furthermore, a start code of a tile header included in an encoded stream is identified, and the start position of the variable-length code and that of the Flexbits are specified based on this information. Then, the variable-length code and Flexbits are parallelly decoded, thereby speeding up the decoding processing. However, this technique is premised on decoding of the stream encoded in a frequency mode of the JPEG XR, which has two types of encoding modes (spatial mode and frequency mode). Since an encoded stream encoded in the spatial mode does not include any header required to identify the start positions of the variable-length code and Flexbits, the start positions of respective codes cannot be specified.

As described above, when the related arts are applied to decoding of a JPEG XR encoded stream, parallel decoding processing of the variable-length code and Flexbits can be executed. However, the circuit scale is greatly increased, or the decoding processing is limited to the specific encoding mode, thus posing problems.

### SUMMARY OF THE INVENTION

The present invention has been made in consideration of the aforementioned problems, and provides a technique for decoding an encoded stream, to which different encoding methods are applied together, more quickly without increasing any circuit scale.

According to the first aspect of the present invention, an image processing apparatus, which entropy-decodes an input encoded stream in some streams of which a variable-length code stream is followed by a semi-fixed-length data stream, comprising: a first decoding unit that reads out a variable-length code stream of interest from a position designated as a start position of the variable-length code stream of interest in the input encoded stream, and decodes the readout variable-length code stream of interest; a second decoding unit that reads out a semi-fixed-length data stream of interest which follows the variable-length code stream of interest from the input encoded stream and decodes the readout semi-fixed-length data stream of interest after the decoding of the variable-length code stream of interest; a determination unit that determines a data length of the semi-fixed-length data stream of interest using a result of the decoding of the variable-length code stream of interest after the decoding of the variable-length code stream of interest; and a control unit that designates a position the data length behind the start position of the semi-fixed-length data stream of interest as a start position of a next variable-length code stream to be decoded after the variable-length code stream of interest, and controls the first decoding unit to start decoding of the next variable-length code stream.

According to the second aspect of the present invention, an image processing method to be executed by an image processing apparatus, which entropy-decodes an input encoded stream in some streams of which a variable-length code stream is followed by a semi-fixed-length data stream, comprising: a first decoding step of reading out a variable-length code stream of interest from a position designated as a start position of the variable-length code stream of interest in the input encoded stream, and decoding the readout variable-length code stream of interest; a second decoding step of reading out a semi-fixed-length data stream of interest which follows the variable-length code stream of interest from the input encoded stream, and decoding the readout semi-fixed-length data stream of interest after the decoding of the variable-length code stream of interest; a determination step of determining a data length of the semi-fixed-length data stream of interest using a result of the decoding of the variable-length code stream of interest after the decoding of the variable-length code stream of interest; and a control step of designating a position the data length behind the start position of the semi-fixed-length data stream of interest as a start position of a next variable-length code stream to be decoded after the variable-length code stream of interest, and controlling the first decoding step to start decoding of the next variable-length code stream.

Further features of the present invention will become apparent from the following description of exemplary embodiments with reference to the attached drawings.

### BRIEF DESCRIPTION OF THE DRAWINGS

FIG. 1 is a block diagram showing an example of the functional arrangement of an image processing apparatus according to the first embodiment;

FIG. 2 is a timing chart of processing according to the first embodiment;

FIG. 3 is a timing chart of processing according to a modification of the first embodiment;

FIG. 4 is a view showing a configuration example of a coefficient prediction error;

FIG. 5 is a view showing the configuration of an encoded stream in a spatial mode;

FIGS. 6A to 6D are views showing examples of the configurations of blocks in the JPEG XR;

FIG. 7 is a view showing an example of a scan order (ScanOrder) of adaptive scan;

FIG. 8 is a view showing a semi-fixed-length data stream;

FIG. 9 is a block diagram showing an example of the functional arrangement of an image processing apparatus according to the second embodiment;

FIG. 10 is a timing chart of processing according to the second embodiment;

FIG. 11 is a block diagram showing an example of the functional arrangement of an image processing apparatus according to the third embodiment;

FIG. 12 is a flowchart of decoding processing according to the fourth embodiment;

FIG. 13 is a timing chart of processing according to the fourth embodiment;

FIG. 14 is a block diagram showing an example of the arrangement of a digital camera; and

FIG. 15 is a block diagram showing an example of the functional arrangement of a decoding unit 1413.

### DESCRIPTION OF THE EMBODIMENTS

Embodiments of the present invention will be described hereinafter with reference to the accompanying drawings. Embodiments to be described hereinafter will exemplify a case in which the present invention is practiced practically, and correspond to practical embodiments of the arrangements described in the scope of the claims.

### Arrangement Common to Respective Embodiments

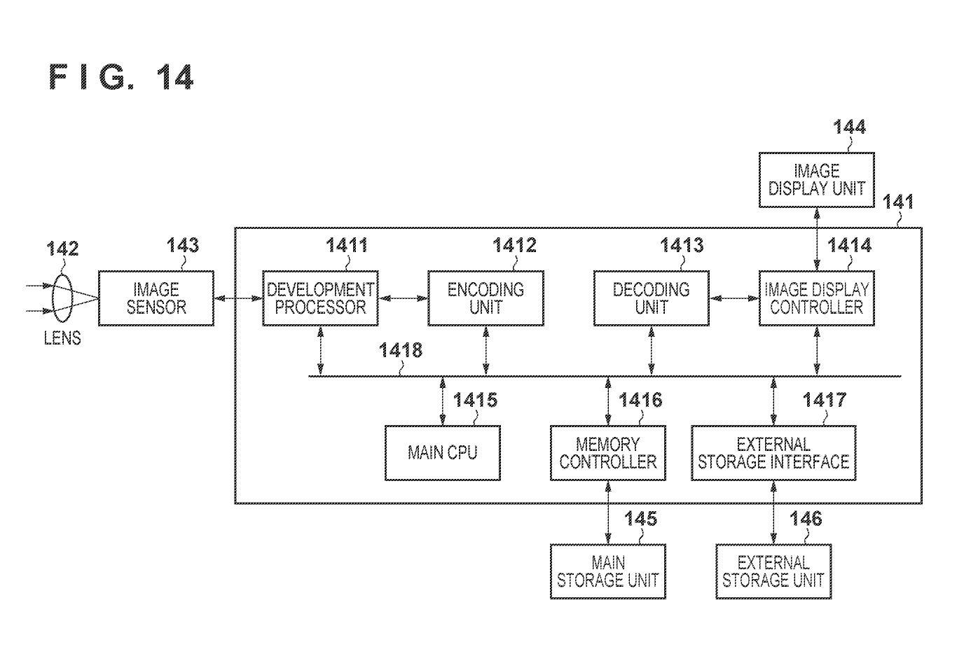

As industrial applications of respective embodiments to be described hereinafter, a digital camera and digital camcorder are known. Thus, in the respective embodiments to be described hereinafter, an image decoding apparatus (image processing apparatus) integrated in an LSI for a digital camera having the arrangement shown in FIG. 14 will be exemplified.

Light coming from an external world including an object forms an image on an image sensor 143 via a lens 142. The image sensor 143 outputs an electrical signal (image signal) corresponding to an intensity of the received light to a development processor 1411.

The development processor 1411 applies known image processing such as image interpolation processing and color conversion processing to this image signal, and outputs the processed signal to an encoding unit 1412 as image data.

The encoding unit 1412 encodes this image data to generate an encoded stream. Then, the encoding unit 1412 outputs this generated encoded stream to a memory controller 1416 or external storage interface 1417 via an internal bus 1418.

The memory controller 1416 controls data read/write accesses to a main storage unit 145. Upon reception of the encoded stream from the encoding unit 1412, the memory controller 1416 writes this encoded stream in the main storage unit 145.

The external storage interface 1417 serves as an interface with an external storage unit 146. Upon reception of the encoded stream from the encoding unit 1412, the external storage interface 1417 writes this encoded stream in the external storage unit 146.

Assume that an instruction to decode the encoded stream written in the main storage unit 145 and to display the decoded image data on an image display unit 144 is input from an operation unit (not shown). In this case, the memory controller 1416 reads out the designated encoded stream, and transfers the readout stream to a decoding unit 1413 via the internal bus 1418.

On the other hand, assume that an instruction to decode the encoded stream written in the external storage unit 146 and to display the decoded image data on the image display unit 144 is input from the operation unit (not shown). In this case, the external storage interface 1417 reads out the designated encoded stream, and transfers the readout stream to the decoding unit 1413 via the internal bus 1418.

The decoding unit 1413 decodes the encoded stream received from the memory controller 1416 or external storage interface 1417, and outputs a decoded image to an image display controller 1414.

The image display controller 1414 converts the decoded image received from the decoding unit 1413 into an analog signal, and outputs the converted analog signal to the image display unit 144. The image display unit 144 includes a liquid crystal panel or the like, and displays an image according to the analog signal received from the image display controller 1414, that is, an image decoded by this apparatus.

A main CPU 1415 executes operation control of the aforementioned units. Of course, processes (or some of them) of some functional units of the aforementioned units may be executed by the main CPU 1415.

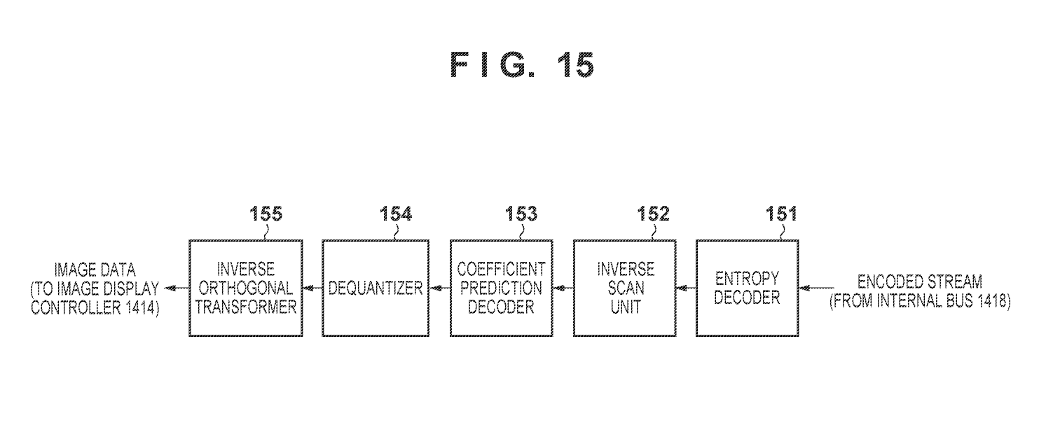

An example of the functional arrangement of the decoding unit 1413 will be described below using the block diagram shown in FIG. 15. As described above, an encoded stream is input to the decoding unit 1413 via the internal bus 1418. This encoded stream is input to an entropy decoder 151.

The entropy decoder 151 entropy-decodes this input encoded stream, and inputs transformation coefficient prediction errors obtained as a result of the entropy decoding to an inverse scan unit 152. The inverse scan unit152 applies known inverse scan to the transformation coefficient prediction errors input from the entropy decoder 151, and inputs the scan result to a coefficient prediction decoder 153 as transformation coefficient prediction errors.

The coefficient prediction decoder 153 generates quantized transformation coefficients by adding prediction errors to the transformation coefficient prediction errors input from the inverse scan unit 152, and inputs the generated quantized transformation coefficients to a dequantizer 154.

The dequantizer 154 dequantizes the quantized transformation coefficients input from the coefficient prediction decoder 153, and inputs transformation coefficients obtained as a result of the dequantization to an inverse orthogonal transformer 155.

The inverse orthogonal transformer 155 applies inverse orthogonal transform to the transformation coefficients input from the dequantizer 154, thereby generating an image. In this way, an image can be decoded from the encoded stream by the respective units included in the decoding unit 1413.

In FIG. 15, when the coefficient prediction is skipped in FIG. 15, the output of the entropy decoder 151 corresponds to quantized transformation coefficients. Furthermore, when the dequantization is also skipped, the output from the entropy decoder 151 corresponds to transformation coefficients. In other words, the entropy decoder 151 decodes data corresponding to subsequent processing and outputs it.

The following embodiments will explain an image processing apparatus applicable to this entropy decoder 151. Also, the following embodiments will explain a case in which an encoded stream obtained from the main storage unit 145, external storage unit 146, encoding unit 1412, or the like is to be decoded.

### First Embodiment

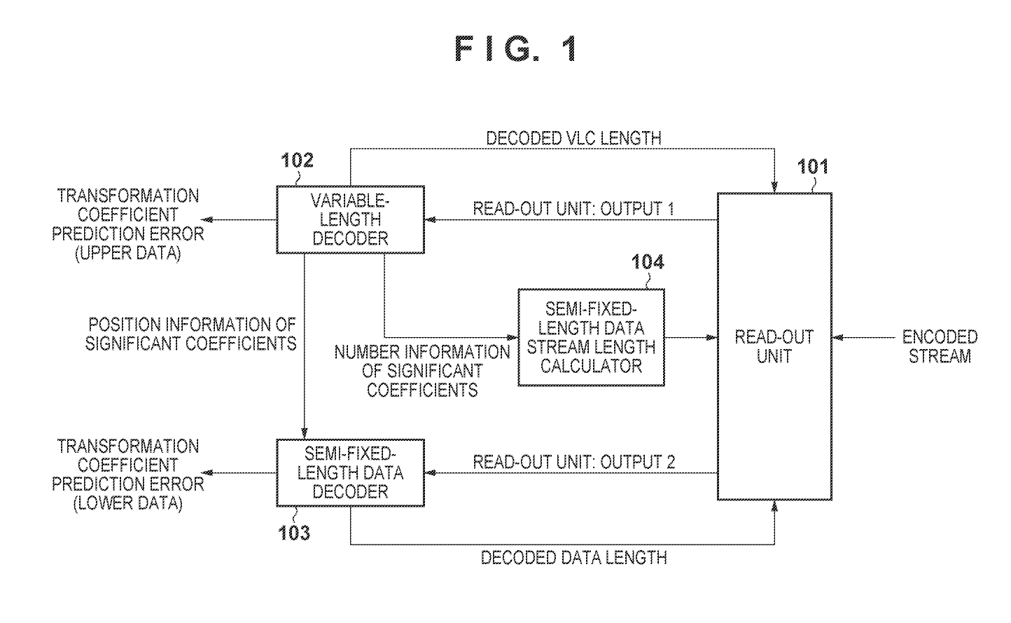

An example of the functional arrangement of an image processing apparatus according to this embodiment will be described first using the block diagram shown in FIG. 1.

To a read-out unit 101, an input encoded stream, which is encoded according to the JPEG XR encoding method, is input. The read-out unit 101 reads out a variable-length code stream as upper data for each transformation coefficient prediction error from a position in the input encoded stream, which position is designated as a start position of an encoded stream of a block of interest, and outputs the readout stream to a variable-length decoder 102 (read-out unit: output 1). Then, upon completion of decoding of the variable-length code stream of the block of interest, the read-out unit 101 reads out, from the input encoded stream, a semi-fixed-length data stream as lower data for each transformation coefficient prediction error, which stream neighbors and follows the variable-length code stream. Then, the read-out unit 101 outputs the readout semi-fixed-length data stream to a semi-fixed-length data decoder 103 (read-out unit: output 2).

Note that the read-out unit 101 may have an arrangement having a read port and a write port, or that having two read ports and two write ports. That is, the read-out unit 101 may adopt arbitrary arrangements as long as it can read out and output a variable-length code stream and semi-fixed-length data stream for each block.

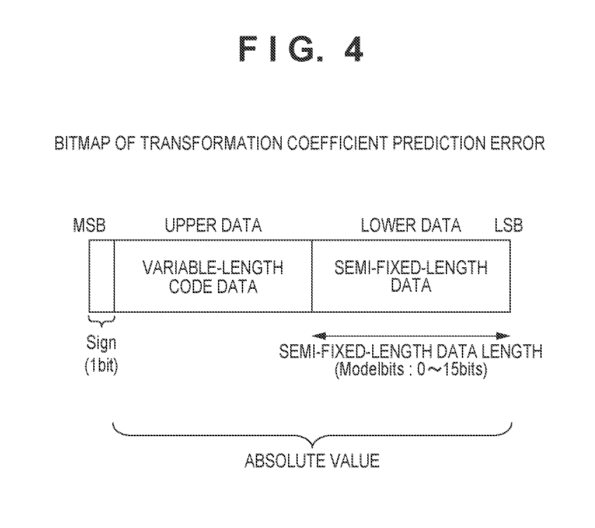

The variable-length decoder 102 decodes the variable-length code stream as the upper data (that in FIG. 4) for each transformation coefficient prediction error of the block of interest, which stream is output from the read-out unit 101 (first decoding). Then, the variable-length decoder 102 outputs the decoded upper data for each transformation coefficient prediction error, and also outputs a code length of the decoded upper data for each transformation coefficient prediction error in association with the block of interest to the read-out unit 101. The decoder 102 may output the code length every time it decodes the upper data or may output a total code length after it has completed decoding of all upper data of the block of interest. Upon completion of decoding of the variable-length code stream of the block of interest, the variable-length decoder 102 outputs the number m of upper data, and the number n of significant upper data of those of the transformation coefficient prediction errors (number information), which are obtained by decoding, to a semi-fixed-length data stream length calculator 104.

The number of significant upper data of the transformation coefficient prediction errors may be counted after completion of decoding of all upper data of the block of interest, or may be counted every time significant upper data appears. Also, when the variable-length decoder 102 decodes significant upper data, it outputs position information of that significant upper data in the block of interest to the semi-fixed-length data decoder 103. When the number m of upper data obtained by decoding the variable-length code stream of the block of interest is given or fixed, it need not be output to the semi-fixed-length data decoder 103.

The semi-fixed-length data stream length calculator 104 calculates the following equations using the numbers m and n from the variable-length decoder 102 and the number Modelbits (0≦Modelbits≦15) (FIG. 4) of bits of lower data of one transformation coefficient prediction error.

L=0 . . . Modelbits=0

L=Modelbits×m+(m−n) . . . Modelbits≠0

With these equations, a data length L of the semi-fixed-length data stream of the block of interest, which stream is output from the read-out unit 101 to the semi-fixed-length data decoder 103, can be calculated. The semi-fixed-length data stream length calculator 104 outputs this calculated data length (semi-fixed-length data stream length) L to the read-out unit 101.

Thus, the read-out unit 101 can designate a position the data length L behind the start position of the semi-fixed-length data stream of the block of interest as a start position of an encoded block of the next block to be decoded. Therefore, the read-out unit 101 reads out the input encoded stream from this designated position, and outputs a variable-length code stream to the variable-length decoder 102 to control the variable-length decoder 102 to start decoding of the variable-length code stream of the next block.

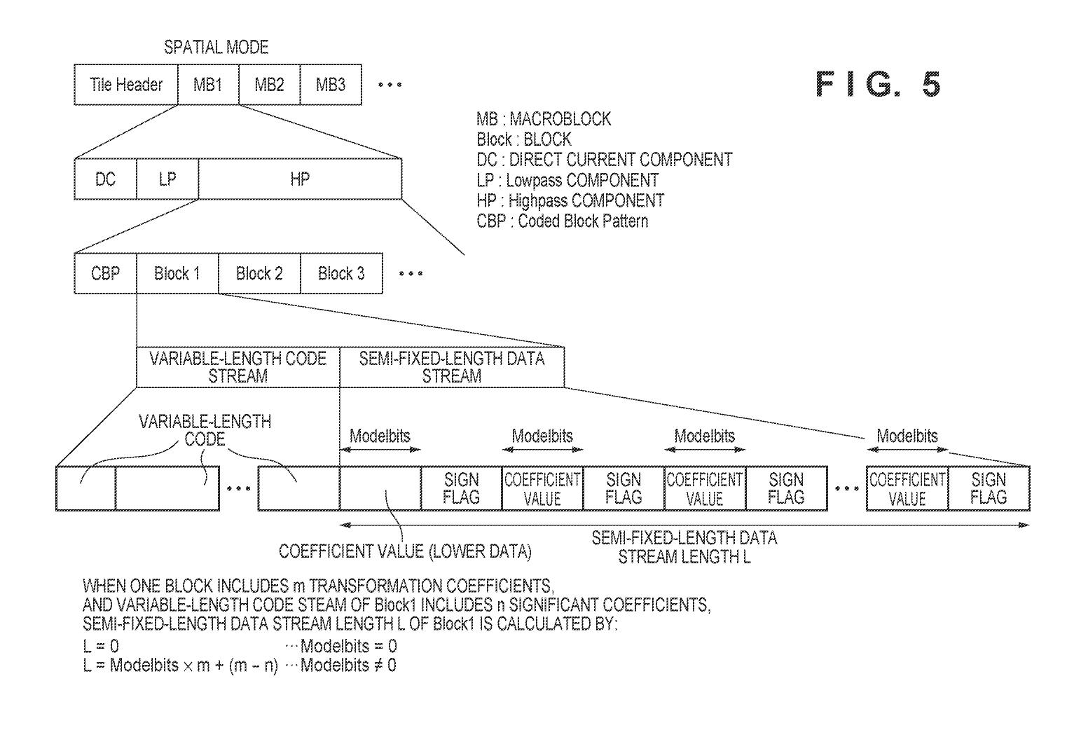

The semi-fixed-length data decoder 103 will be described below. The operation (second decoding) of the semi-fixed-length data decoder 103 when the configuration of an input encoded stream is that of an encoded stream in the spatial mode will be described below. FIG. 5 shows the configuration of an encoded stream in the spatial mode.

In the JPEG XR, an image is divided into a plurality of tiles, and this tile is divided into a plurality of macroblocks (MBs). An encoded stream of each MB (MB1, MB2, MB3, . . . ) further includes those of DC, LP (Lowpass), and HP (Highpass) components, which are obtained by applying the orthogonal transform to the image. The HP component includes encoded streams for respective blocks (Block1, Block2, Block3, . . . ) An encoded stream of each block includes a variable-length code stream including a variable-length code group obtained by variable-length encoding upper data, and an encoded stream of a lower data group. A CBP (Coded Block Pattern) is information required for each block to discriminate the presence/absence of significant coefficients of upper data. When all upper data of one block are insignificant coefficients, a variable-length code stream of that block does not exist. For this reason, variable-length code streams of which blocks an encoded stream includes are discriminated based on the CBP.

An encoded stream of lower data (semi-fixed-length data stream) has a configuration of an encoded stream in which semi-fixed-length data (coefficient values in FIG. 5) and corresponding sign bits are alternately coupled. In the JPEG XR, for significant upper data, a sign bit is assigned to encoded variable-length data. Hence, this sign bit is assigned to only semi-fixed-length data corresponding to insignificant upper data.

Therefore, when the semi-fixed-length data decoder 103 determines that upper data is insignificant based on a Modelbits value and significant coefficient position information of upper data, it decodes both semi-fixed-length data and a sign flag. When upper data is significant, the decoder 103 decodes only semi-fixed-length data. The decoder 103 outputs a decoded data length to the read-out unit 101 every time it decodes data. The each block shown in FIG. 1 is controlled by a control unit (not shown).

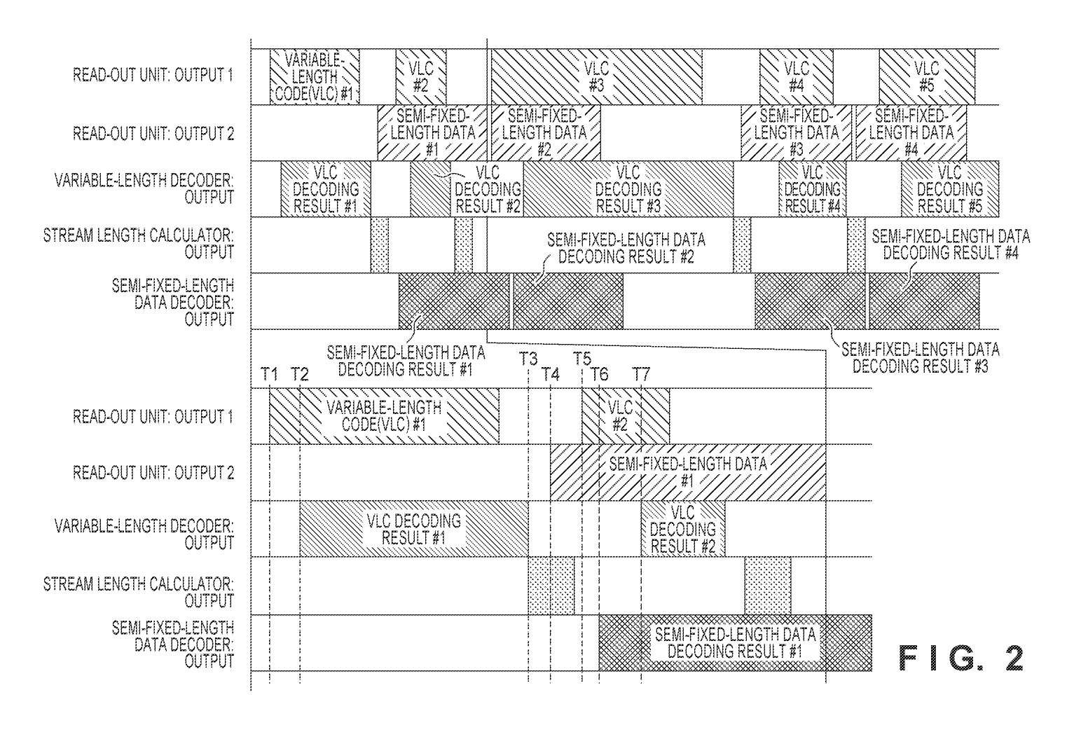

The operations of the respective units shown in FIG. 1 will be described below taking the timing chart shown in FIG. 2 as an example.

At time T1, the read-out unit 101 begins to read out a VLC (Variable Length Code) #1 in a block #1, and outputs the readout VLC to the variable-length decoder 102 as [read-out unit: output 1]. Then, the variable-length decoder 102 begins to decode this VLC #1.

At time T2, the variable-length decoder 102 begins to output decoded upper data. At time T3, the variable-length decoder 102 completes decoding and outputting of all upper data of the VLC #1. Also, at time T3, the variable-length decoder 102 outputs the number of upper data and the number of significant upper data (significant coefficients) of those upper data, which are obtained by decoding of the VLC #1, to the semi-fixed-length data stream length calculator 104. Then, the semi-fixed-length data stream length calculator 104 calculates a semi-fixed-length data stream length L of the block #1, as described above, and outputs it to the read-out unit 101 as [stream length calculator: output].

At time T4, the read-out unit 101 begins to read out semi-fixed-length data #1 in the block #1, and outputs the readout semi-fixed-length data #1 to the semi-fixed-length data decoder 103 as [read-out unit: output 2]. Then, the semi-fixed-length data decoder 103 begins to decode the semi-fixed-length data #1. Also, the read-out unit 101 designates a position the semi-fixed-length data stream length L behind the start position of the semi-fixed-length data #1 of the block #1 as a start position of a VLC #2 of a block #2.

Then, at time T5, the read-out unit 101 begins to read out the VLC #2 of the block #2 from this designated position, and outputs the readout VLC to the variable-length decoder 102 as [read-out unit: output 1]. Thus, the variable-length decoder 102 begins to decode this VLC #2.

At time T6, the semi-fixed-length data decoder 103 begins to output the decoded semi-fixed-length data #1. At time T7, the variable-length decoder 102 begins to output decoded upper data of the VLC #2.

From time T7, since the semi-fixed-length data #1 of the block #1 and the VLC #2 of the block #2 are parallelly decoded, high-speed decoding can be attained. That is, the variable-length decoder 102 and semi-fixed-length data decoder 103 can perform parallel operations. Likewise, since semi-fixed-length data #2 of the block #2 and a VLC #3 of a block #3 are parallelly decoded, high-speed decoding can be attained. The same applies to the subsequent blocks, and a description thereof will not be given.

As described above, according to the aforementioned arrangement, since semi-fixed-length data of a block #N (N-th block) and a VLC of a block #(N+1) can be parallelly read out and decoded, the decoding processing (entropy decoding processing) can be speeded up. Note that N is an integer equal to or larger than 1.

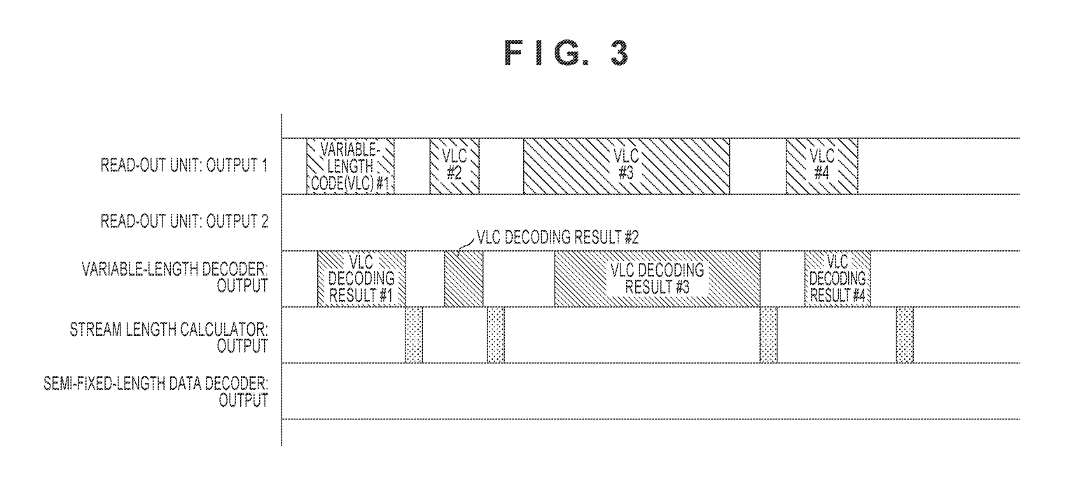

Note that in the arrangement shown in FIG. 1, the semi-fixed-length data decoder 103 may be substantially stopped, and only a variable-length code stream may be decoded. The timing chart shown in FIG. 3 shows the operations of the respective units shown in FIG. 1 when only a variable-length code stream is to be decoded.

In the timing chart shown in FIG. 3, upon completion of decoding of the VLC #1 in the block #1, the semi-fixed-length data stream length calculator 104 calculates a semi-fixed-length data stream length L of the block #1. Then, the read-out unit 101 designates a position the semi-fixed-length data stream length L behind the start position of the semi-fixed-length data #1 of the block #1 as a start position of the VLC #2 of the block #2. The variable-length decoder 102 decodes the VLC #2 of the block #2 from this designated position. That is, in this case, after the read-out unit 101 reads out the VLC #1 of the block #1, it skips a read access of the semi-fixed-length data #1, and reads out the VLC #2 of the block #2. Note that a mode in which the read-out unit 101 reads out semi-fixed-length data and outputs the readout semi-fixed-length data to the semi-fixed-length data decoder 103, but the semi-fixed-length data decoder 103 does not operate may be adopted.

The case has been explained wherein a scan order is given (significant coefficient position information can be quickly obtained) for the sake of simplicity. However, in the JPEG XR encoding, an encoding order of coefficients (upper data in FIG. 4) is changed as needed depending on frequencies of occurrence of significant coefficients. That is, an order of scanning (sorting) coefficients is adaptively changed according to the frequencies of occurrence, thereby devising to improve encoding efficiency. This method is called an adaptive scan.

Therefore, the semi-fixed-length data decoder 103 has to execute decoding corresponding to this adaptive scan, but it can execute decoding at the same timings as those shown in FIG. 2. A scan order determination method executed at the time of encoding is described in detail in the JPEG XR recommendation. For this reason, a description thereof will not be given, and how the semi-fixed-length data decoder 103 executes decoding based on information of the scan order for each block will be described.

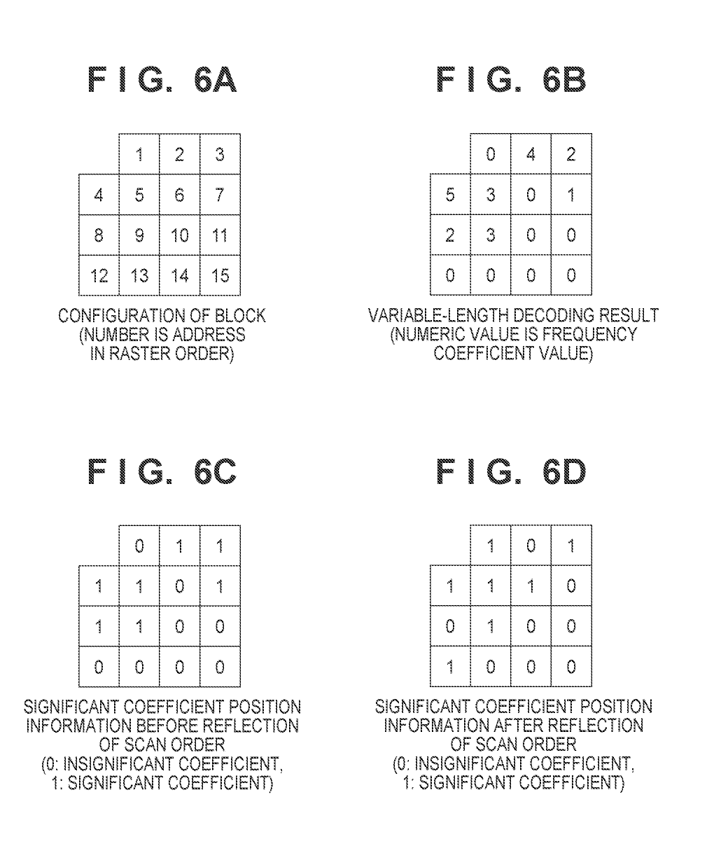

FIG. 6A shows an example of the configuration of a block in the JPEG XR. As shown in FIG. 6A, one block includes 15 transformation coefficients. Significant coefficient position information is information indicating the ordinal number of an address at which a significant coefficient exists in the block shown in FIG. 6A. The significant coefficient position information is generated using an order of adaptive scan (not shown) to be applied to upper data as the decoding result of the variable-length decoder 102.

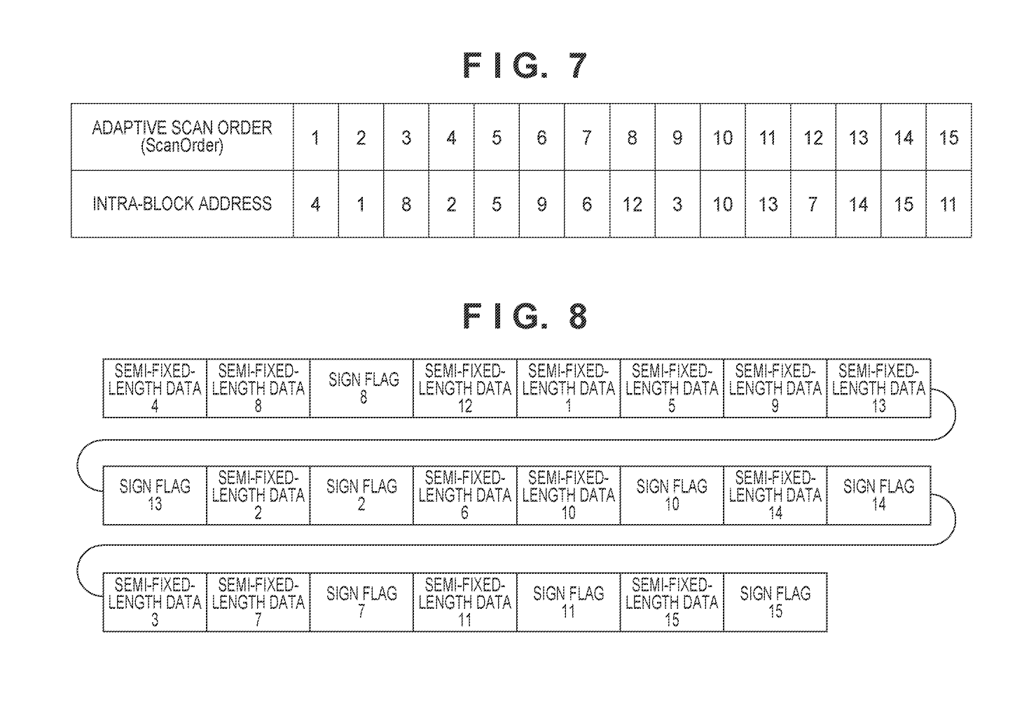

FIG. 7 shows an example of the scan order (ScanOrder) of the adaptive scan. The scan order in decoding corresponds to coefficient decoding order information. A case will be taken into account wherein the decoding result shown in FIG. 6B is obtained by the variable-length decoding. FIG. 6C shows information in which “1” is assigned to significant coefficient addresses, and “0” is assigned to insignificant coefficient addresses in FIG. 6B. Furthermore, the information in FIG. 6C is sorted based on the scan order shown in FIG. 7, thereby generating significant coefficient position information shown in FIG. 6D.

The series of processes can be executed parallel to decoding of a VLC of the subsequent block #(N+1). That is, significant/insignificant coefficient addresses are sequentially determined in turn based on decoded upper data, and “1” and “0” can be set for addresses in consideration of the scan order. In this case, the function of generating significant coefficient position information may be independently provided to a unit outside the variable-length decoder 102, or may be provided to the semi-fixed-length data decoder 103.

The semi-fixed-length data decoder 103 decodes semi-fixed-length data based on the Modelbits value and significant coefficient position information. Upon referring to the significant coefficient position information shown in FIG. 6D, a semi-fixed-length data stream shown in FIG. 8 is to be decoded. In FIG. 6D, as for addresses corresponding to insignificant upper data (addresses 2, 7, 8, 10, 11, 13, 14, and 15), semi-fixed-length data with sign bits are decoded. As for other addresses corresponding to significant upper data, semi-fixed-length data without any sign bit are decoded.

As can be seen from the above description, with this processing, according to the aforementioned processing, the first embodiment is applicable independently of the presence/absence of the adaptive scan. As can also be seen from the above description, even when several cycles are spent from completion of decoding of each block until generation and outputting of the significant coefficient position information, the effects of the first embodiment will not be reduced. In the first embodiment, the semi-fixed-length data stream length calculator 104 is independently provided. However, the function equivalent to the semi-fixed-length data stream length calculator 104 may be provided to the variable-length decoder 102, semi-fixed-length data decoder 103, or read-out unit 101.

Note that the arrangement shown in FIG. 1 is may be adopted for only HP(including flexbits) decoding or for only DC/LP(including FLC refinement) decoding. Needless to say, the arrangement is may be adopted for both decoding.

### Second Embodiment

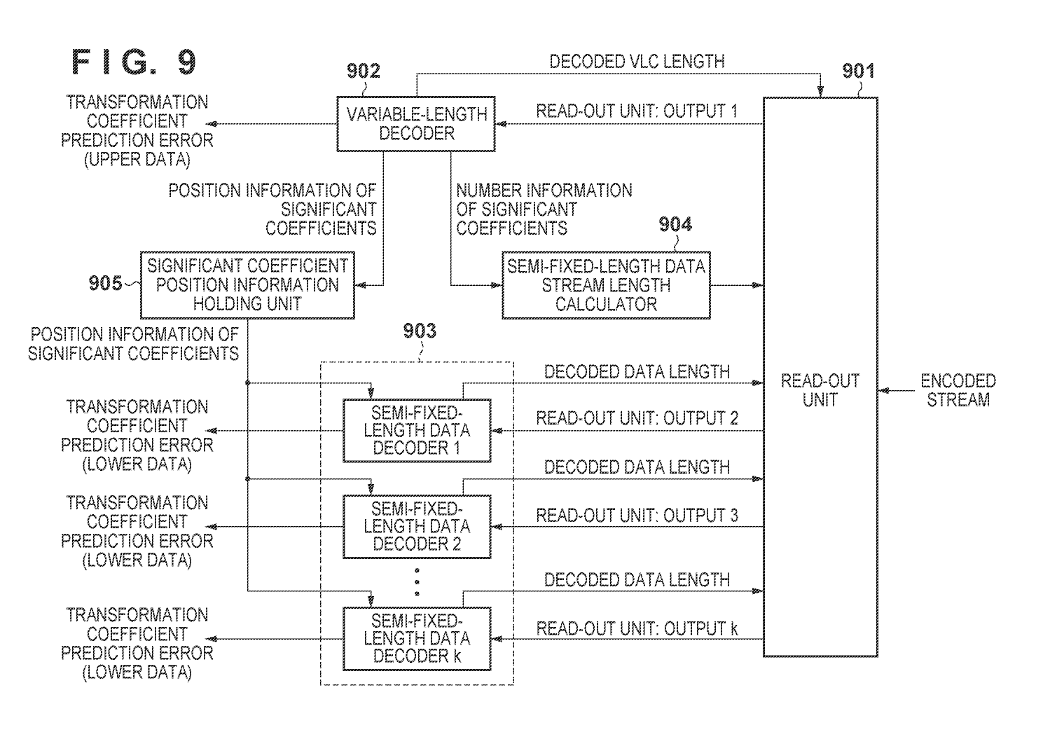

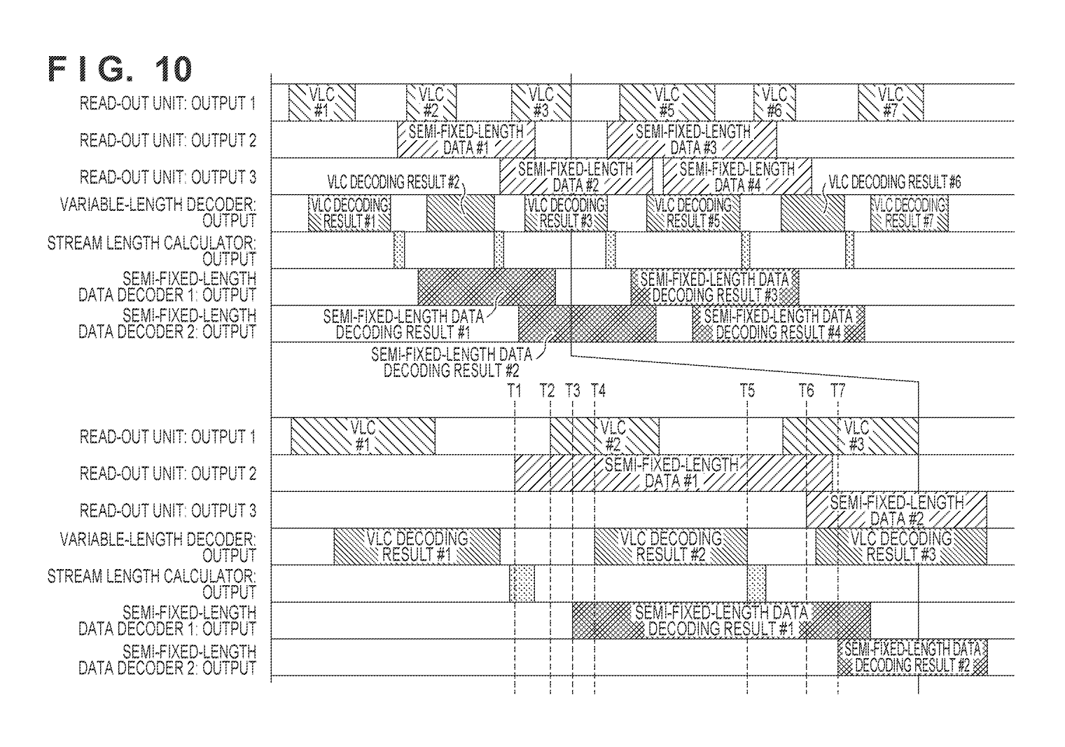

An example of the functional arrangement of an image processing apparatus according to this embodiment will be described below using the block diagram shown in FIG. 9. As shown in FIG. 9, the image processing apparatus according to this embodiment is different from that according to the first embodiment in that k (≧2) decoders used to decode a semi-fixed-length data stream are included, and a holding unit used to store position information of significant upper data of transformation coefficient prediction errors is included. Since the k decoders used to decode a semi-fixed-length data stream are included, a read-out unit 901 executes switching control to which decoder a semi-fixed-length data stream is to be output.

A variable-length decoder 902 and semi-fixed-length data stream length calculator 904 perform the same operations as the variable-length decoder 102 and semi-fixed-length data stream length decoder 104, and a description thereof will not be repeated.

A significant coefficient position information holding unit 905 is used to store position information indicating positions of significant upper data of transformation coefficient prediction errors in a block when the variable-length decoder 902 has completed decoding of that block. Assume that this significant coefficient position information holding unit 905 has a capacity that can store pieces of position information for k blocks.

A semi-fixed-length data decoder 903 includes semi-fixed-length data decoders 1 to k. The semi-fixed-length data decoders 1 to k perform the same operation as the semi-fixed-length data decoder 103, and can operate parallelly.

For example, assume that when a semi-fixed-length data stream of a block #N and a variable-length code stream of a block #(N+1) are parallelly decoded, the variable-length decoding ends earlier. In such case, according to this embodiment, decoding of a semi-fixed-length data stream of the block #(N+1) is started without waiting for completion of the decoding of the semi-fixed-length data stream of the block #N.

The operations of the respective units shown in FIG. 9 when k=2, that is, the semi-fixed-length data decoder 903 includes semi-fixed-length data decoders 1 and 2 will be described below using the timing chart shown in FIG. 10. Note that processes different from the first embodiment will be mainly explained below, but a description of the same processes will not be repeated.

At time T1, the variable-length decoder 902 has completed decoding and outputting of a VLC #1 of a block #1, and the semi-fixed-length data stream length calculator 904 calculates a data length L of a semi-fixed-length data stream #1 of the block #1. Then, at time T1, the read-out unit 901 begins to output the semi-fixed-length data stream #1 to the semi-fixed-length data decoder 1.

At time T2, the read-out unit 901 begins to output a VLC #2 of a block #2 to the variable-length decoder 902. The decoding result of the semi-fixed-length data stream #1 whose decoding has begun at time T1 by the semi-fixed-length data decoder 1 is output from time T3.

The variable-length decoder 902 begins to output the decoding result of the VLC #2 from time T4, and completes this outputting at time T5. At this timing, decoding and outputting of the semi-fixed-length data stream #1 are not complete yet.

Thus, from time T6, the read-out unit 901 outputs a semi-fixed-length data stream #2 to the semi-fixed-length data decoder 2 as an inactive decoder. Then, at time T7, the semi-fixed-length data decoder 2 begins to output the decoding result of the semi-fixed-length data stream #2. Parallel to decoding of the semi-fixed-length data streams of the blocks #1 and #2, a VLC of a block #3 is also decoded.

In this manner, when k=2, semi-fixed-length data streams of blocks #N and #(N+1) and a VLC of a block #(N+2) can be parallelly decoded, and the processing performance can be further speeded up compared to the first embodiment.

When it is apparent based on a CBP that a block does not include any VLC, decoding of semi-fixed-length data can be started without waiting for the decoding result of the variable-length decoder 902. This is because if no VLC is included, since all significant coefficients of upper data are “0”, a data length of a semi-fixed-length data stream is allowed to be calculated.

Note that the above description is similarly applicable even when k assumes an arbitrary value, needless to say. Also, each of the semi-fixed-length data decoders 1 to k may include the significant coefficient position information holding unit 905.

### Third Embodiment

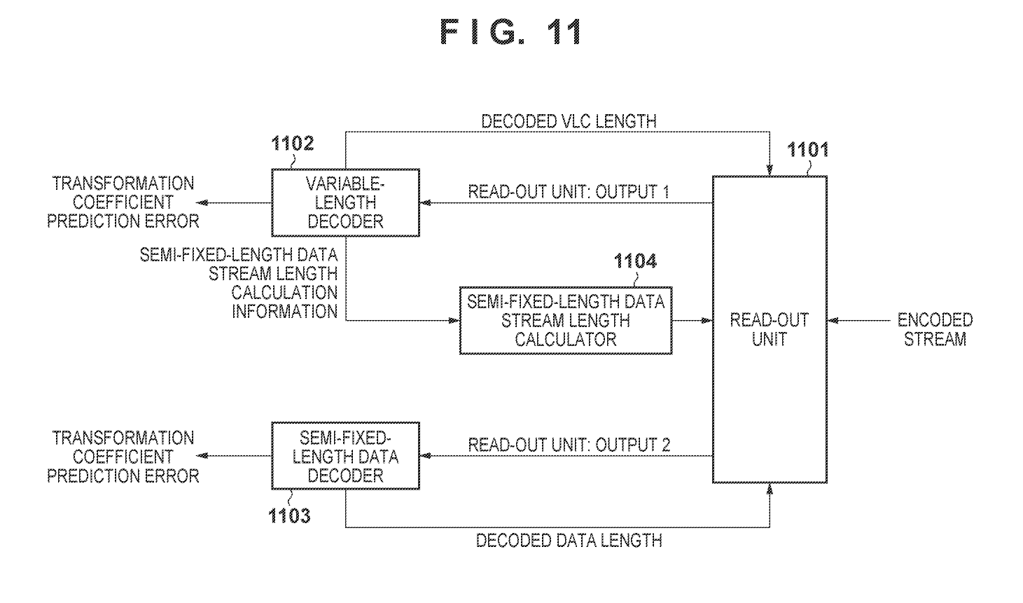

The present invention is not limited to the encoding format of the JPEG XR encoding. An example of the functional arrangement of an image processing apparatus according to this embodiment will be described below using the block diagram shown in FIG. 11. In this embodiment, an encoded stream, which is generated according to an encoding method other than the JPEG XR encoding, is to be decoded. For example, an encoded stream in which a block #N is fully variable-length encoded, and a subsequent block #(N+1) is fully encoded as semi-fixed-length data is to be decoded. Assume that information required to calculate a stream length (data length) of a semi-fixed-length data stream (semi-fixed-length data stream length calculation information in FIG. 11) is obtained by decoding a VLC. For example, semi-fixed-length data stream length calculation information obtained by decoding the block #N may directly indicate a data length of the semi-fixed-length data of the subsequent block #(N+1). In either case, this embodiment is applicable to an encoding format having a relationship in which based on the decoding result of a VLC, a data length of semi-fixed-length data that follow that VLC can be derived.

A read-out unit 1101 and variable-length decoder 1102 perform the same operations as the read-out unit 101 and variable-length decoder 102, but the variable-length decoder 1102 does not output any information about the number and positions of significant transformation coefficient prediction errors.

A semi-fixed-length data decoder 1103 decodes a semi-fixed-length data stream in the same manner as the semi-fixed-length data decoder 103. In this case, the semi-fixed-length data decoder 1103 does not use any position information of significant transformation coefficient prediction errors. A semi-fixed-length data stream length calculator 1104 operates in the same manner as the semi-fixed-length data stream length calculator 104, and calculates each individual semi-fixed-length data stream length.

In the third embodiment, the decoding results of the variable-length decoder 1102 and semi-fixed-length data decoder 1103 are transformation coefficient prediction errors, but they need not always be transformation coefficient prediction errors. These decoding results may be those according to the processes of the subsequent stages. Also, semi-fixed-length data stream length calculation information may be supplied from an external unit (not shown) in place of the variable-length decoder 1102.

As described above, according to this embodiment, even in decoding of an encoded stream in which a semi-fixed-length data stream length is determined based on the decoding result of a VLC, semi-fixed-length data of a block #N and a VLC of a block #(N+1) can be parallelly decoded. Of course, this encoded stream is that, which is generated according to an encoding method other than the JPEG XR encoding method.

The timing chart of the processes is the same as that shown in FIG. 2. Needless to say, even when each individual data length of semi-fixed-length data is constant (in case of fixed-length data), this embodiment can attain parallel decoding operations.

That is, the aforementioned efficient entropy decoding processing can be attained as long as an input encoded stream is as follows independently of its encoding method. That is, the aforementioned efficient entropy decoding processing can be attained as long as an input encoded stream includes a semi-fixed-length data stream which follows a variable-length code stream in at least some streams. Alternatively, the aforementioned efficient entropy decoding processing can be attained as long as an input encoded stream alternately includes variable-length code streams and semi-fixed-length data streams in at least some streams.

An image processing apparatus which applies entropy decoding processing to such input encoded stream operates as follows.

From a position designated as a start position of a variable-length code stream of interest in an input encoded stream, that variable-length code stream of interest is read out and decoded. Upon completion of this decoding, a semi-fixed-length data stream of interest which follows the variable-length code stream of interest is read out from the input encoded data stream, and is decoded. Furthermore, upon completion of the decoding of the VLC stream of interest, a data length of the semi-fixed-length data stream of interest is determined using that decoding result. For example, the data length of the semi-fixed-length data stream of interest is calculated using the number of transformation coefficients obtained by this decoding, the number of significant transformation coefficients of the obtained transformation coefficients, and the number of bits of one transformation coefficient. Then, a position the data length behind the start position of the semi-fixed-length data stream of interest is designated as a start position of a next variable-length code stream to be decoded after the variable-length code stream of interest, and decoding of the next variable-length code stream is started.

### Fourth Embodiment

This embodiment will explain a case in which the functions of the image processing apparatus described in the above embodiments are implemented as software (JPEG XR decoder) which runs on a PC having a multi-core CPU or a multi-core CPU for an embedded apparatus. In this case, for example, the main CPU 1415 shown in FIG. 14 may execute this software.

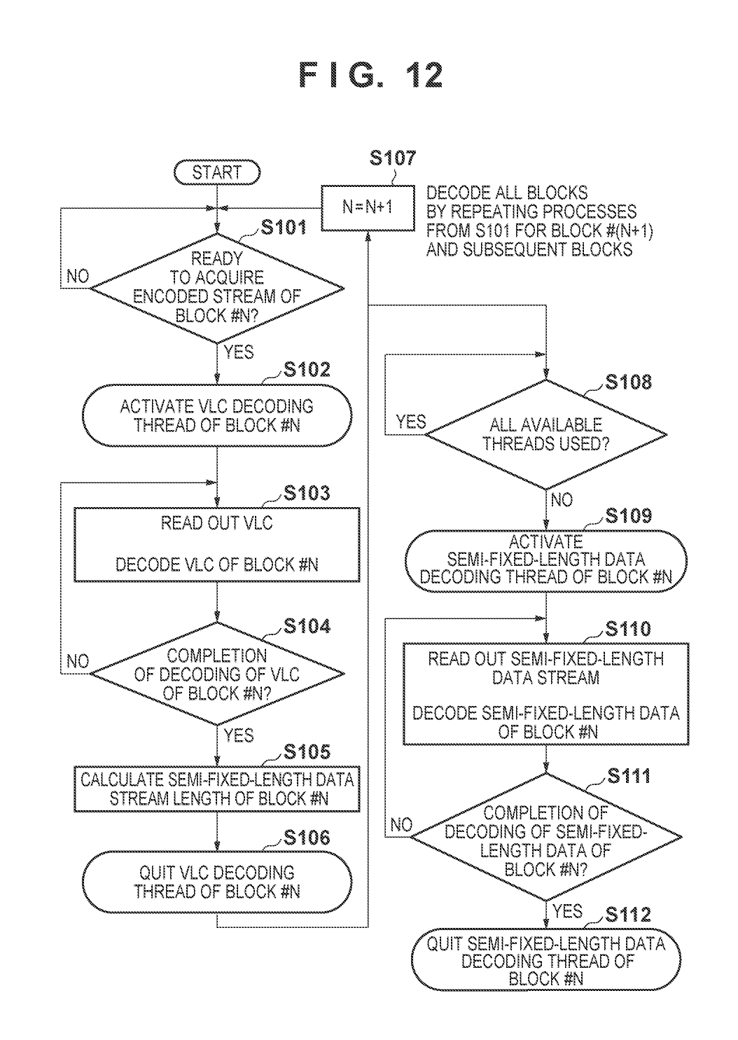

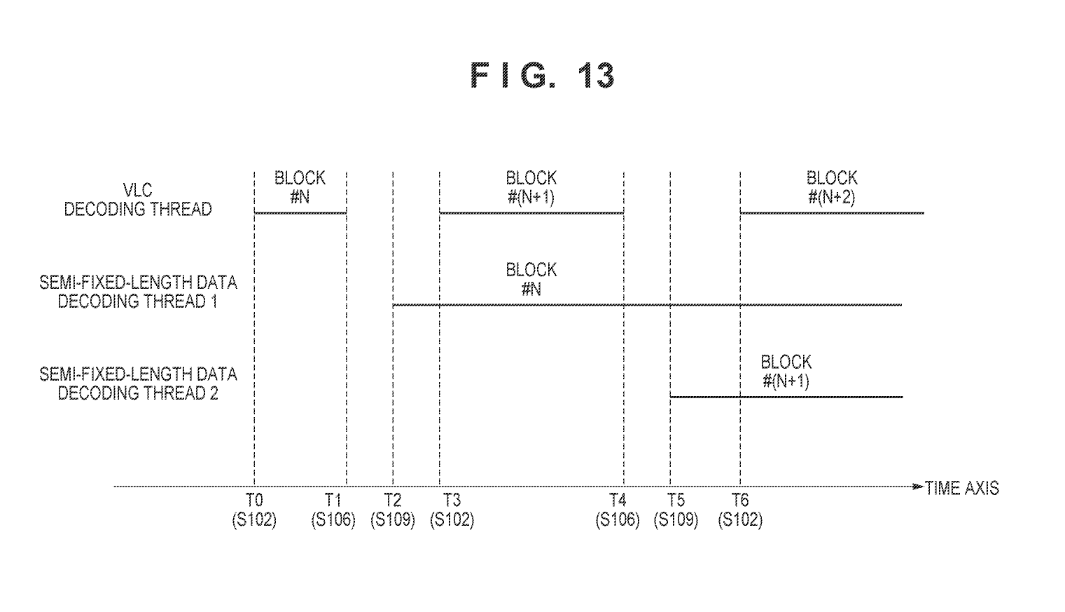

Processing to be executed by an apparatus which executes software when the functions of the image processing apparatus described in the above embodiments is implemented by the software will be described below using FIG. 12 which shows the flowchart of that processing. Note that a main body of processes in respective steps shown in FIG. 12 is a CPU of this apparatus.

If an encoded stream of a block #N is ready to be acquired, the process advances to step S102 via step S101. The CPU activates a decoding processing thread of a VLC #N in step S102, so as to read out the VLC #N from the encoded stream of the block #N and to decode the readout VLC #N in step S103. The CPU continues the process in step S103 until this decoding is completed. Upon completion of this decoding, the process advances to step S105 via step S104.

In step S105, the CPU calculates a semi-fixed-length data stream length of a semi-fixed-length data stream #N. In step S106, the CPU quits the thread activated in step S102.

After step S106, the CPU executes the process in step S107, and those in step S108 and subsequent steps. In step S107, the CPU increments a variable N by “1” to apply the processes in step S101 and subsequent steps to the next block.

In step S108, the CPU compares the number of available threads assigned from, for example, an OS (Operating system), and the number of currently running threads. Then, if all the available threads are used, the CPU stands by in step S108. If the available threads include one or more inactive threads, the process advances to step S109 via step S108.

In step S109, the CPU activates a decoding processing thread of the semi-fixed-length data stream #N. In step S110, the CPU reads out the semi-fixed-length data stream #N from the block #N and decodes the readout stream. The CPU continues the process in step S110 until this decoding is completed. Upon completion of this decoding, the process advances to step S112 via step S111. In step S112, the CPU quits the thread activated in step S109.

If respective threads can run on individual CPU cores, the semi-fixed-length data of the block #N and a VLC of a block #(N+1) can be parallelly decoded. In the same manner as in the second embodiment, the semi-fixed-length data of the block #N and semi-fixed-length data of a block after the block #(N+1) can also be parallelly decoded.

FIG. 13 is a timing chart showing the processing according to the flowchart shown in FIG. 12. At time T0 (step S102), if an encoded stream of the block #N is ready to be acquired, the CPU activates the decoding processing thread of a VLC #N. Then, the CPU reads out the VLC #N from the encoded stream of the block #N, decodes the readout VLC #N, and calculates a semi-fixed-length data stream length of a semi-fixed-length data stream #N. This thread quits at time T1 (step S106).

After that, at time T2 (step S109), the CPU activates the decoding processing thread of the semi-fixed-length data stream #N, reads out the semi-fixed-length data stream #N from the encoded stream of the block #N, and decodes the readout semi-fixed-length data stream #N. At time T3 (step S102), if an encoded stream of the block #(N+1) is ready to be acquired, the CPU activates the decoding processing thread of a VLC #(N+1). The CPU then reads out the VLC #(N+1) from the encoded stream of the block #(N+1), decodes the readout VLC #(N+1), and calculates a semi-fixed-length data stream length of a semi-fixed-length data stream #(N+1). This thread quits at time T4 (step S106). At this time, the decoding processing of the semi-fixed-length data stream #N is not complete yet.

At time T5 (step S109), the CPU activates the decoding processing thread of the semi-fixed-length data stream #(N+1), reads out the semi-fixed-length data stream #(N+1) from the encoded stream of the block #(N+1), and decodes the readout semi-fixed-length data stream #(N+1). Of course, this processing is executed only when it is determined in step S108 that the available threads include one or more inactive threads, and the semi-fixed-length data stream #(N+1) is ready to be read out.

At time T6 (step S102), if an encoded stream of a block #(N+2) is ready to be acquired, the CPU activates the decoding processing thread of a VLC #(N+2). Then, the CPU reads out the VLC #(N+2) from the encoded stream of the block #(N+2), decodes the readout VLC #(N+2), and calculates a semi-fixed-length data stream length of a semi-fixed-length data stream #(N+2).

Therefore, from time T6, the semi-fixed-length data of the blocks #N and #(N+1) and the VLC of the block #(N+2) are parallelly decoded. Needless to say, the number of blocks of the semi-fixed-length data to be parallelly decoded is not limited to two. The semi-fixed-length data stream length calculation method and the significant coefficient position information generation method required at the time of decoding of semi-fixed-length data of the first embodiment are applicable.

The application to the digital camera has been explained, and the JPEG XR encoding method has been described as the first to fourth embodiments. However, as can be seen from the above description, an application range is not limited to the digital camera, and the encoding method is not limited to the JPEG XR encoding method.

Some or all of the units shown in FIGS. 1, 9, and 11 except for the significant coefficient position information holding unit 905 may be implemented as software (computer program). Especially, in case of software implementation, VLC decoding and semi-fixed-length data decoding can be executed as multi-threads, as described in the fourth embodiment.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-093512 filed Apr. 19, 2011, and No. 2012-074889 filed Mar. 28, 2012, which are hereby incorporated by reference herein in their entirety.

What is claimed is:

1. An image processing apparatus, which entropy-decodes an input encoded stream in some streams of which a variable-length code stream is followed by a semi-fixed-length data stream, comprising:
a first decoding unit that reads out a variable-length code stream of interest from a position designated as a start position of the variable-length code stream of interest in the input encoded stream, and decodes the readout variable-length code stream of interest;
a second decoding unit that reads out a semi-fixed-length data stream of interest which follows the variable-length code stream of interest from the input encoded stream and decodes the readout semi-fixed-length data stream of interest after the decoding of the variable-length code stream of interest;
a determination unit that determines a data length of the semi-fixed-length data stream of interest using a result of the decoding of the variable-length code stream of interest after the decoding of the variable-length code stream of interest; and
a control unit that designates a position the data length behind the start position of the semi-fixed-length data stream of interest as a start position of a next variable-length code stream to be decoded after the variable-length code stream of interest, and controls said first decoding unit to start decoding of the next variable-length code stream.

2. The apparatus according to claim 1, wherein upon completion of the decoding of the variable-length code stream of interest, said determination unit determines the data length of the semi-fixed-length data stream of interest using the number of coefficients obtained by the decoding of the variable-length code stream of interest, the number of significant coefficients of the obtained coefficients, and the number of bits of each semi-fixed-length data.

3. The apparatus according to claim 2, wherein letting m be the number of coefficients obtained by the decoding of the variable-length code stream of interest, n be the number of significant coefficients of the obtained coefficients, and Modelbits (0≦Modelbits≦15) be the number of bits of each semi-fixed-length data, said determination unit calculates a data length L of the semi-fixed-length data stream of interest by calculating:
L=0 . . . Modelbits=0
L=Modelbits×m+(m−n) . . . Modelbits≠0

4. The apparatus according to claim 2, wherein said second decoding unit includes a plurality of decoders which are configured to operate parallelly, and
every time said first decoding unit has completed decoding of one variable-length code stream, one of inactive decoders reads out a semi-fixed-length data stream which neighbors and follows that variable-length code stream from the input encoded stream, and decodes the readout semi-fixed-length data stream.

5. The apparatus according to claim 2, wherein said first decoding unit and said second decoding unit are configured to operate parallelly.

6. The apparatus according to claim 2, wherein the variable-length code stream is upper data for each transformation coefficient prediction error which forms a block, and the semi-fixed-length data stream is lower data for each transformation coefficient prediction error which forms the block.

7. An image processing method to be executed by an image processing apparatus, which entropy-decodes an input encoded stream in some streams of which a variable-length code stream is followed by a semi-fixed-length data stream, comprising:
a first decoding step of reading out a variable-length code stream of interest from a position designated as a start position of the variable-length code stream of interest in the input encoded stream, and decoding the readout variable-length code stream of interest;
a second decoding step of reading out a semi-fixed-length data stream of interest which follows the variable-length code stream of interest from the input encoded stream, and decoding the readout semi-fixed-length data stream of interest after the decoding of the variable-length code stream of interest;
a determination step of determining a data length of the semi-fixed-length data stream of interest using a result of the decoding of the variable-length code stream of interest after the decoding of the variable-length code stream of interest; and
a control step of designating a position the data length behind the start position of the semi-fixed-length data stream of interest as a start position of a next variable-length code stream to be decoded after the variable-length code stream of interest, and controlling the first decoding step to start decoding of the next variable-length code stream.

8. A non-transitory computer-readable storage medium storing a computer program for controlling a computer to function as respective units of an image processing apparatus of claim 1.
